(19) United States
(12) Patent Application Publication
(10) Pub. No.: US 2020/0385172 A1
(43) Pub. Date: Dec. 10, 2020

(54) COOLER ATTACHMENT DEVICE

(71) Applicants: Jason Reed, Orlando, FL (US); Jessica Pruitt, Orlando, FL (US)

(72) Inventors: Jason Reed, Orlando, FL (US); Jessica Pruitt, Orlando, FL (US)

(21) Appl. No.: 16/432,814

(22) Filed: Jun. 5, 2019

(51) Int. Cl. B65D 25/20; F16B 2/08; F16B 2/00; F25D 11/00

(52) U.S. Cl. CPC B65D 25/20; F25D 11/003; F16B 2/005; F16B 2/08

(57) ABSTRACT

A cooler attachment device includes an elongated strap having a dimension that is suitable for extending around a longitudinal axis of a cooler. A buckle is provided to adjust the length of the strap and to secure the strap onto the cooler. A plurality of beverage holders are pivotally secured onto the strap at any number of different locations. A plurality of hollow grips are provided, each having a hollow main body through which the strap is positioned. A storage bag having a waterproof construction and an interior space for storing objects is removably secured to the strap.

### TECHNICAL FIELD

The present invention relates generally to beverage coolers, and more particularly to an attachment device for a beverage cooler.

### BACKGROUND

The statements in this section merely provide background information related to the present disclosure and may not constitute prior an.

Coolers are used for storage and transport of beverages and food items in a manner that keeps the interior space cold (or hot) for an extended period of time. Coolers are well known in the art and typically include an insulated body that defines an interior space into which ice and the food/beverage items are placed. Most modern coolers have cupholders formed onto the top surface of the lid so as to allow the lid to be used as a table upon reaching a final destination.

As coolers are most commonly used at outdoor locations such as beaches, fields, and parks, for example, most coolers include wheels along one side that allow the cooler to be pulled from a vehicle to the final destination. Once a user arrives at the destination, the cooler is accessible and the integrated cupholders can then be used. Cooler capacity is limited to the space inside the cooler, a cooler attachment increases the volume of contents that can be transported or taken to a destination to later be add inside the cooler once the original interior cooler contents have been distinguished increasing coolers total carrying capacity.

Although useful, the conventional design of such coolers results in many practical inconveniences to a user. For example, during transport of the cooler, a user has no place to store opened beverages, and if carrying an open beverage it occupies the users hand(s) from carrying other object(s) possibly creating additional trips to or from their destination or additional walking or wasted time for the user” and must wait until the final destination to partake in the same. This is problematic when the user must walk great distances between the vehicle and the final destination. Additionally, upon reaching the final destination, all users must remove their beverages from the integrated cup holders each time access to the cooler interior is needed. This often results in one or more of the opened beverages to spill or be accidentally dropped.

Finally, owing to the shallow design of the integrated cupholders, if the cooler is placed on uneven ground, or if the cooler is bumped with sufficient force, beverages in the cupholders have a tendency to tip over and spill the contents all over the cooler body and anyone sitting nearby. Also when mixing or pouring drinks into cups or glasses the cooler lid would have to be closed with cups or glasses on top of the cooler lid putting limitations to the number of different pouring items the user can hold or access simultaneously to what can be held in their two hands. A cooler attachment device allows the items needing to pour to remain in the cooler, allowing to access them all simultaneously bypassing any other additional tables or chairs typically used in this situation and the cooler attachment device holds the cups or glasses on the outer border of the cooler creating a serving station.

Accordingly, it would be beneficial to provide a cooler attachment device having a plurality of pivoting cupholders for use at any time, so as to eliminate the drawbacks described above.

### SUMMARY OF THE INVENTION

The present invention is directed to a cooler attachment device. One embodiment of the present invention can include a elongated strap having a dimension that is suitable for extending around a longitudinal axis of a cooler. A buckle can be provided to adjust the length of the strap and to secure the strap onto the cooler. A plurality of beverage holders can be pivotally secured onto the strap at any number of different locations.

In one embodiment, a plurality of hollow grips are provided. Each of the grips can include a hollow main body through which the strap can be positioned. Each of the grips can preferably be positioned along the corner sections of the cooler and function to maintain the strap and beverage holders stationary on the cooler. In one embodiment, a bag can be secured onto the strap. The bag can include a waterproof construction and an interior space for storing objects.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of a cooler attachment device that is useful for understanding the inventive concepts disclosed herein.

FIG. 2 is a side view of a beverage holder of the cooler attachment device, in accordance with one embodiment of the invention.

FIG. 3 is a front view of a storage bag of the cooler attachment device, in accordance with one embodiment of the invention.

FIG. 4A is a perspective view of the cooler attachment device in operation, in accordance with one embodiment of the invention.

FIG. 4B is another perspective view of the cooler attachment device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the terms “connector” and “complementary connector” include any number of different elements that work together to repeatedly join two items together in a nonpermanent manner. Several nonlimiting examples include opposing strips of hook and loop material (i.e. Velcro®), attractively-oriented magnetic elements, flexible strips of interlocking projections with a slider (i.e., zipper), tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

As described herein, the term “pivotally secured” “rotatably secured” and derivatives thereof shall be used interchangeably to describe a situation wherein two identified objects are joined together in a manner that allows one or both of the objects to pivot, and/or rotate about or in relation to the other object. Several nonlimiting examples of devices for pivotally connecting objects together include traditional single hinge mechanisms, ball joint couplers, and/or swivel flanges, for example. One suitable example of a pivot clip for use herein is described in U.S. Pat. No. 6,038,742, the contents of which are incorporated herein by reference.

Although described throughout this document for use with a cooler, this is for illustrative purposes only. To this end, those of skill in the art will recognize that the inventive concepts disclosed herein may be utilized with any number of other devices, and will have particular advantageous features for use with any device that encounters rotation or movement during transport. Accordingly, the inventive concepts are not to be construed as limiting only for use on/with a cooler.

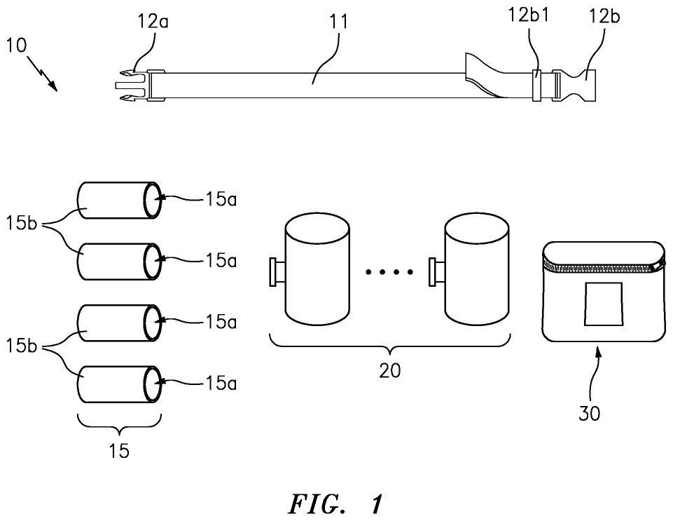

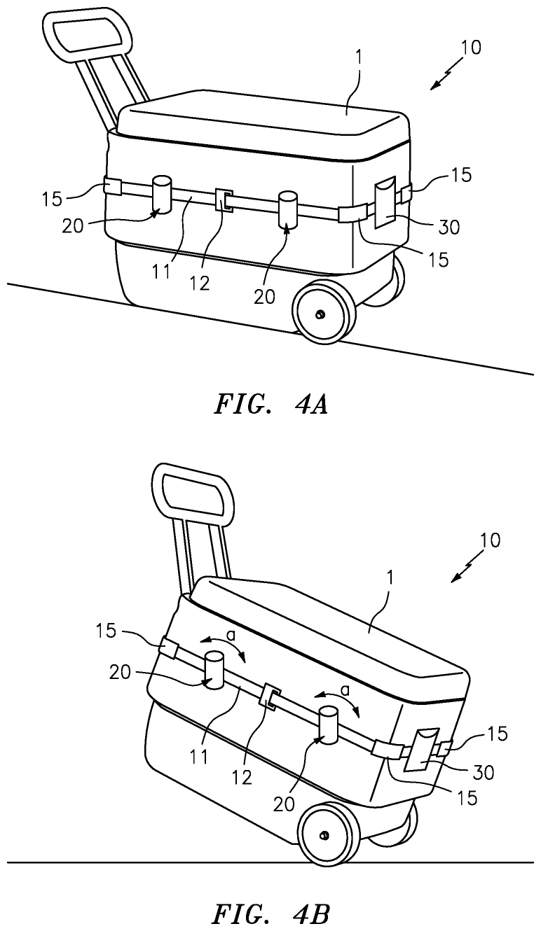

FIGS. 1-4B illustrate one embodiment of a cooler attachment device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 4.

As shown in FIG. 1, the device 10 can include, essentially, an elongated strap 11, a plurality of grips 15, a plurality of beverage holders 20 and a storage container 30.

In the preferred embodiment, the strap 11 can be constructed from an elongated piece of nylon or polypropylene webbing which is known to have excellent tensile strength and superior resistance to tearing. The strap 11 can include any number of different lengths and widths, and/or may be designed with a specific length so as to accommodate coolers of known shapes and sizes without needing user adjustments. Of course, the tether is not to be construed as limiting to such materials, as any number of other materials capable of being secured about the body of a cooler in the manner described herein are also contemplated.

In one embodiment, a buckle 12 having pair of buckle segments 12a and 12b can be positioned along the strap and can function to selectively secure the strap around a cooler. In the preferred embodiment, the buckle segments 12a and 12b can comprise a side release buckle and receiver, having a channel 12b1 for adjusting the length of the strap; however, any number of other connectors are also contemplated.

Each of the grips 15 can include a hollow channel 15a for receiving the strap 11, and an outside surface 15b for engaging the corners of a cooler body. In the preferred embodiment, the grips can be constructed from a high friction material to prevent the strap 11 from sliding or moving along the surface of a cooler. To this end, a “high friction material” can include any number of different materials that, when engaging a secondary object provide a greater level of resistance to movement than what the strap provides alone. Several nonlimiting examples of high friction materials include, rubber and silicon carbide, for example.

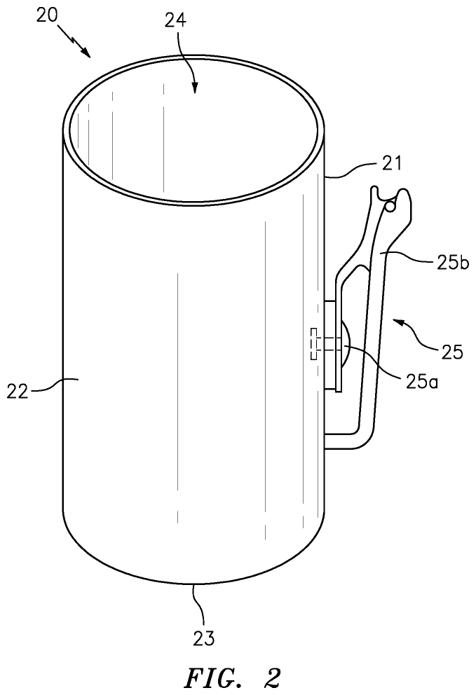

FIG. 2 illustrates one embodiment of a beverage holder 20 for use with the device. As shown, the holder can include a generally planar back surface 21, and a circular shaped body 22 extending outward from the back surface. The body including a closed bottom end 23, and an open top end 24. The beverage holder may be constructed so as to be rigid in nature, malleable in nature, or as a combination of both. For example, the back surface 21 may be constructed from a semi-rigid plastic or composite material, and the circular body may be constructed from a malleable material such as nylon, for example. Of course, any number of other combinations of shapes, sizes and construction materials are contemplated.

As shown, a clip 25 can be secured along the back surface of the cup holder. In the preferred embodiment, the clip can include a swivel-type clip having a central pin 25a that is secured to the back surface 21 opposite to the circular body 22. The pin can extend through one arm of a spring-loaded alligator clamp 25b so as to allow the clamp to rotate 360 degrees about the pin. In this regard, a user can open and close the arms of the clamp to secure the holder 20 to any portion of the strap 11.

The use of swivel-clips is preferred as they advantageously allow the beverage holders to pivot during use, thereby maintaining beverages stored within the body in an upright orientation at all times, regardless of the angle of the cooler to which it is secured. As such, a user pulling a cooler over uneven terrain can store an opened beverage within one of the holders 20 and not worry about spilling the same. Of course, the beverage holder and clip are not to be construed as limiting to the above noted design, as any number of other shapes, sizes, construction materials and connectors are contemplated.

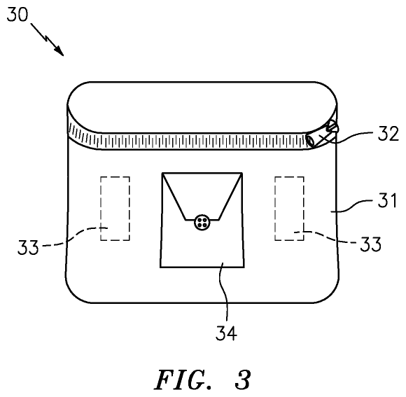

FIG. 3 illustrates one embodiment of a storage bag 30 which can be secured along the strap 11. As shown, the bag can include a main body 31 having any number of different shapes, sizes and construction materials. In the preferred embodiment, the bag can be constructed from nylon canvas, for example, which is durable and has waterproof capabilities. As shown, a zipper 32 or other such connector can be secured along the bag body for allowing access to the interior portion. A pair of loops 33 can be provided along the back surface of the bag through which the strap 11 can be positioned. Additionally, one or more outside pockets 34 may be provided along the bag body. The bag can function to allow a user to conveniently store personal items such as a smartphone, keys and the like. In various embodiments, the zipper can include a locking mechanism that allows the user to lock the zipper 32 in the closed position.

Of course, the bag 30 is not limited to the above noted features or construction materials. To this end, other embodiments are contemplated where the bag includes different types of connectors which can secure the bag to the tether in either a permanent or removable manner.

FIGS. 4A and 4B illustrate one embodiment of the device in operation. As shown, the strap can be positioned longitudinally along the cooler body 1 with the gripping elements 15 moved to each corner. When so positioned, the buckle segments 12a and 12b can be secured together and the length of the strap can be adjusted until it is tight against the cooler. As described herein, the term “tight” refers to a tension of the strap that is sufficient to secure the strap to the cooler body without allowing movement of the strap relative to the cooler.

Once positioned onto the cooler, one or more beverage holders 20 can be secured onto the strap at any desirable location, and beverages or other items can be stored within the holder(s). Finally, as shown in FIG. 4B, a user can lift the cooler 1 to any desirable angle while moving the same and the beverage holders will remain completely vertical owing to the pivotal functionality of the clip (arrow a). Such a feature keeping the beverages and other items stored within the beverage holders upright at all times regardless of the orientation of the cooler.

Accordingly, the above described device allows users to store beverages and other items along the exterior of the cooler body in a manner that does not interfere with operation of the cooler lid and that allows users a place to store beverages during transport of the cooler itself.

As described herein, one or more elements of the cooler attachment device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A cooler attachment device, comprising:
an elongated strap having a first end, a second end and a middle portion;
a buckle comprising a first buckle section that is positioned along the strap adjacent to the first end, and a second buckle section that is positioned along the strap adjacent to the second end; and
at least one beverage holder that is configured to be secured onto the strap,
wherein the strap includes a length that is suitable for being positioned longitudinally along a cooler body, and the buckle is configured to secure the strap to the cooler body.

2. The device of claim 1, further comprising:
a plurality of grips that are disposed along the elongated strap.

3. The device of claim 2, wherein each of the grips include a main body that is constructed from a high friction material.

4. The device of claim 3, wherein a location of each of the grips along the elongated strap is adjustable.

5. The device of claim 1, wherein the at least one beverage holder is secured to the strap by a clip.

6. The device of claim 5, wherein the clip includes functionality for rotating an orientation of the beverage holder relative to an orientation of the strap.

7. The device of claim 1, further comprising:
a storage bag that is configured to be secured to the strap.
